(19) United States
(12) Patent Application Publication
(10) Pub. No.: US 2024/0314673 A1
(43) Pub. Date: Sep. 19, 2024

(54) MONITORING WIRELESS DEVICES IN A COMMUNICATION NETWORK

(71) Applicant: Telefonaktiebolaget LM Ericsson (publ), Stockholm (SE)

(72) Inventors: Yatin RAJWADHA, Noida (IN); Rajeev RANJAN PRASAD, Gurgaon, Haryana (IN)

(73) Assignee: Telefonaktiebolaget LM Ericsson (publ), Stockholm (SE)

(21) Appl. No.: 18/576,601

(22) PCT Filed: Jul. 5, 2021
(86) PCT No.: PCT/IN2021/050653

§ 371 Date: Jan. 4, 2024

(51) Int. Cl. H04W 40/24; H04W 4/029

(52) U.S. Cl. CPC H04W 40/24; H04W 4/029

(57) ABSTRACT

According to an aspect there is provided a computer-implemented method of operating a register node (300; 705) in a communication network. The method comprises maintaining (801) a first list of identifiers of wireless devices (701) for which a notification has been requested when the wireless device (701) connects 5 to the communication network; receiving (803) a check request from a mobility management node (703) in the communication network, the check request comprising a first identifier of a wireless device (701) that is requesting access to the communication network; determining (805) if the first identifier is in the first list of identifiers; and, if the first identifier is in the first list of identifiers, sending (807) a notification to a client node (400; 708, 709) that is external to the communication network, the notification indicating that a wireless device 0 (701) having the first identifier is connecting to the communication network.

### TECHNICAL FIELD

This disclosure relates to the monitoring of wireless devices in a communication network, and in particular to techniques for enabling a client node external to the communication network to obtain information about a wireless device of interest.

### BACKGROUND

The 5^{th} Generation (5G) Equipment Identity Register (5G-EIR) is a key node for the authentication of wireless devices (also known as user equipments—UEs) in a 5G/New Radio (NR) communication network, including Internet-of-Things (IoT) devices, thereby preventing the misuse of the communication network and the abuse of paid services. The 5G-EIR is an independent network component coupled via Service Based Interfaces (SBI) that helps network operators to protect their networks. The 5G-EIR provides a mechanism to prevent malicious wireless devices from registering/connecting with the communication network. The 5G-EIR can maintain one or more lists of identifiers of wireless devices that can be used to determine whether a particular wireless device can be allowed access to the communication network. The wireless device identifiers can be Permanent Equipment Identifiers (PEIs). The one or more lists can include any of a ‘black list’, a ‘grey list’ and a ‘white list’.

Wireless devices on a black list can be, for example, wireless devices that have been reported as lost, stolen or owned by a criminal party, and these wireless devices do not have permission to access the communication network (i.e. the wireless devices are barred). Typically wireless devices on the black list are identified individually, i.e. by a unique wireless device identifier, such as a PEI.

A grey list can be used to identify, for example, certain wireless device models or software versions that do not behave correctly with respect to the network, and these wireless devices can be blocked from accessing the network. Wireless devices on the grey list may be identified individually, e.g. by a unique wireless device identifier, or by software version and/or model number.

A white list can be used to identify wireless devices that are permitted to access the communication network and the services the communication network provides. Wireless devices on the white list may be identified individually, e.g. by a unique wireless device identifier.

It will be appreciated that maintaining both a black list and a white list may be unnecessary if the lists are used in an exclusive manner, i.e. all wireless devices would be on one list or the other, and therefore it is sufficient to maintain only one of these lists.

EIRs are present in other generations of communication networks, such as 4th Generation (4G)/Long Term Evolution (LTE), 3rd Generation (3G)/Universal Mobile Telecommunications System (UMTS), etc.

A Gateway Mobile Location Centre (GMLC) contains functionality required to support location-based services (LBS). Location-based services are services that make use of location data for a wireless device and can share this location data with the wireless device, or other services that can make use of the location data. The GMLC is the first node an external LBS client accesses in a Global System for Mobile (GSM) communications, UMTS or LTE network. The GMLC interacts with the Radio Access Network (RAN) as well as other network nodes to obtain the location of a wireless device whenever this is requested.

A Location Service Client (LCS Client) is a logical functional entity that can send a request to the GMLC to find a location of a UE in a communication network. LCS Clients can subscribe to the GMLC to obtain location information. LCS Clients may or may not interact with human users. The LCS Client is responsible for formatting and presenting data and managing the user interface. A LCS client can be owned by the operator of the communication network, or it can be owned by a third party, for example an official entity such as a government intelligence agency or police force. Generally, a LCS client application is a commercially-licensed product for which the cost of use can be based on the number of location requests generated and processed by the GMLC.

The 5G Network Exposure Function (NEF) facilitates the secure, robust, developer-friendly access to exposed network services and 5G network capabilities. This access is provided by a set of northbound RESTful or web-style application program interfaces (APIs) from the network domain to both internal and external applications. Internal applications are those that are within the network operator's ‘trust domain’. The NEF is defined in the 5G standards as an intelligent, service-aware “border gateway” that will enable an external application function (AF) to communicate with the 5G network functions (NFs).

In 5G terminology, the LCS client, or a server of an official entity, such as a country's intelligence agency server, is considered as an External Application Function or External AF, since it is external to the operator's network. The External AF can be an external entity hosted by the network operator, or by any third party. The External AF generally holds, or can invoke, the LCS client for obtaining or tracking the location of a wireless device.

The 5G NEF provides both northbound APIs (as defined in 3GPP TS 29.522 v17.0.0) and southbound APIs (3GPP TS 29.591 v17.1.0). The NEF Northbound interface exists between the NEF and AFs, whereas the NEF Southbound interface exists between the NEF and 5G NFs. The NEF Northbound interface is used to expose certain functionalities that will be consumed by external AFs. The NEF southbound interface consumes 5G service-based interfaces of different NFs of 5G networks.

One of the northbound services is the “Nnef_Location service” which can be used by AFs to request LBS.

### SUMMARY

An issue with the use of the 5G-EIR (and EIRs in earlier generation networks) is that activation of a wireless device that has been marked as stolen or lost, or is otherwise suspect, is not able to be reported in real time to an official entity that is outside the communication network, such as a police force or intelligence agency. While the official entity is able to use a LCS Client to request information on the location of a particular wireless device, the LCS client does not know whether the wireless device is active in the communication network, and so often location requests are sent for wireless devices that are not connected to the network.

Thus, in the current architecture there is no mechanism to automatically initiate tracking and reporting when a lost/stolen/suspect wireless device is switched on and connects (or tries to connect) to the communication network. Currently, any lawful interception agency applies tracking to wireless devices irrespective of whether the wireless device is in a switched-on or switched-off state. Sending location requests for wireless devices that are switched off and cannot be tracked puts unnecessary load on the LCS client application as well as on the GMLC. Moreover, an extra cost can be incurred to the network operator by the LCS client application vendor if request-based licensing is in place.

Thus, currently the 5G specifications 3GPP TS 29.511, 23.501 and 23.502 do not specify anything about triggering functionality for a 5G-EIR to an external AF.

The techniques described herein propose to report switch-on activity of any wireless device on the black/grey list (or other list stored or maintained by a register node such as an EIR) to an external client node, e.g. a LCS client. The external client node can be any AF outside the network operator's trusted environment, and may be hosted in the cloud. A trigger can be configured in the register node so that when a wireless device having a specific identifier (e.g. PEI, an International Mobile Equipment Identity (IMEI), a Subscription Permanent Identifier (PEI), or a General Public Subscription Identifier (GPSI)) on the list tries to connect to the communication network, a notification is sent to the external client node indicating that the wireless device is connecting to the communication network. The trigger can be configured in the register node by the network operator itself either on request or by mutual agreement with an external AF. The register node trigger can be generated by the register node during the wireless device registration flow, when the identifier (e.g. PEI, IMEI, SUPI, GPSI) of the wireless device is checked against the register node database/list. Based on the register node configuration, the trigger can be generated for any specific, black-listed or grey-listed wireless devices. The register node may use the communication network's Internet gateway to send the notification to the external AF.

These techniques may have a number of different use cases. A first use case may be for a government of a country that would like to know when any stolen, lost, unidentified, or specific wireless device is used or switched-on. The government may have an intelligence agency server deployed in the cloud, and a switch-on trigger can be sent to the server to assist with identifying any terrorist or suspicious activity in real time, and to enhance security measures against unidentified handsets.

A second use case can be for a network operator to reduce the load on the GMLC and client node (e.g. LCS application) by reducing the unnecessary sending of location requests for wireless devices that are switched off, and the unnecessary application of location requests or tracking to wireless devices which are not in a switched-on or connected state.

In a third use case, a network operator may wish to reduce the license cost paid to a LCS client application vendor by reducing unnecessary requests for tracking of switched-off or disconnected wireless devices.

In a fourth use case, a network operator may wish to provide a chargeable service to an official entity, e.g. a government, where every stolen, lost, unidentified, or specific wireless device that is used or switched-on by any means is reported in real time to the official entity.

In a fifth use case, the communication network can allow the latching or connection of a black- or grey-listed wireless device to the communication network, while providing a notification to the client node and initiating location tracking of the wireless device. This means the communication network can be used as a ‘honey pot’ for the black- or grey-listed wireless devices, enabling the official entity to observe and intercept potential criminal behaviour.

According to a first aspect, there is provided a method, or a computer-implemented method, of operating a register node in a communication network. The method comprises maintaining a first list of identifiers of wireless devices for which a notification has been requested when the wireless device connects to the communication network; receiving a check request from a mobility management node in the communication network, the check request comprising a first identifier of a wireless device that is requesting access to the communication network; determining if the first identifier is in the first list of identifiers; and if the first identifier is in the first list of identifiers, sending a notification to a client node that is external to the communication network, the notification indicating that a wireless device having the first identifier is connecting to the communication network.

According to a second aspect, there is provided a method, or a computer-implemented method, of operating a client node. The method comprises receiving a notification from a register node in a communication network, the notification indicating that a wireless device having a specified identifier is connecting to the communication network.

According to a third aspect, there is provided a method, or a computer-implemented method, of operating a network exposure function, NEF, in a communication network. The method comprises receiving a notification request from a client node external to the communication network, the notification request indicating one or more identifiers of wireless devices for which notifications are requested when the wireless devices connect to the communication network; and sending the notification request to a register node in the communication network.

According to a fourth aspect, there is provided a computer program product comprising a computer readable medium having computer readable code embodied therein, the computer readable code being configured such that, on execution by a suitable computer or processor, the computer or processor is caused to perform the method according to the first aspect, the second aspect, the third aspect, or any embodiments thereof.

According to a fifth aspect, there is provided a register node configured for use in a communication network. The register node is configured to maintain a first list of identifiers of wireless devices for which a notification has been requested when the wireless device connects to the communication network; receive a check request from a mobility management node in the communication network, the check request comprising a first identifier of a wireless device that is requesting access to the communication network; determine if the first identifier is in the first list of identifiers; and, if the first identifier is in the first list of identifiers, send a notification to a client node that is external to the communication network, the notification indicating that a wireless device having the first identifier is connecting to the communication network.

According to a sixth aspect, there is provided a client node configured to receive a notification from a register node in a communication network, the notification indicating that a wireless device having a specified identifier is connecting to the communication network.

According to a seventh aspect, there is provided a network exposure function, NEF, configured for use in a communication network. The NEF is configured to receive a notification request from a client node external to the communication network, the notification request indicating one or more identifiers of wireless devices for which notifications are requested when the wireless devices connect to the communication network; and send the notification request to a register node in the communication network.

According to an eighth aspect, there is provided a register node configured for use in a communication network. The register node comprising a processor and a memory, said memory containing instructions executable by said processor whereby said register node is operative to maintain a first list of identifiers of wireless devices for which a notification has been requested when the wireless device connects to the communication network; receive a check request from a mobility management node in the communication network, the check request comprising a first identifier of a wireless device that is requesting access to the communication network; determine if the first identifier is in the first list of identifiers; and if the first identifier is in the first list of identifiers, send a notification to a client node that is external to the communication network, the notification indicating that a wireless device having the first identifier is connecting to the communication network.

According to a ninth aspect, there is provided a client node comprising a processor and a memory. The memory contains instructions executable by said processor whereby said client node is operative to receive a notification from a register node in a communication network, the notification indicating that a wireless device having a specified identifier is connecting to the communication network.

According to a tenth aspect, there is provided a network exposure function, NEF, configured for use in a communication network. The NEF comprises a processor and a memory, said memory containing instructions executable by said processor whereby said NEF is operative to receive a notification request from a client node external to the communication network, the notification request indicating one or more identifiers of wireless devices for which notifications are requested when the wireless devices connect to the communication network; and send the notification request to a register node in the communication network.

### BRIEF DESCRIPTION OF THE DRAWINGS

Some of the embodiments contemplated herein will now be described more fully with reference to the accompanying drawings, in which:

FIG. 1 shows an example of a communication system in accordance with some embodiments;

FIG. 2 is an illustration of the logical connections in the communication system;

FIG. 3 shows a register node in accordance with some embodiments;

FIG. 4 shows a client node in accordance with some embodiments;

FIG. 5 shows a network exposure function (NEF) in accordance with some embodiments;

FIG. 6 is a block diagram illustrating a virtualization environment in which functions implemented by some embodiments may be virtualized;

FIG. 7 is a signalling diagram illustrating the monitoring of wireless devices in a communication network in accordance with some embodiments;

FIG. 8 is a flow chart illustrating a method of operating a register node in accordance with some embodiments;

FIG. 9 is a flow chart illustrating a method of operating a client node in accordance with some embodiments; and

FIG. 10 is a flow chart illustrating a method of operating a NEF in accordance with some embodiments.

### DETAILED DESCRIPTION

As noted above, it is proposed to report switch-on activity of any wireless device on the black/grey list (or other list stored or maintained by a register node such as an EIR) to an external client node, e.g. a LCS client. The external client node can be any AF outside the network operator's trusted environment, and may be hosted in the cloud. A trigger can be configured in the register node so that when a wireless device having a specific identifier (e.g. PEI, IMEI, SUPI, GPSI) on the list tries to connect to the communication network, a notification is sent to the external client node indicating that the wireless device is connecting to the communication network. The trigger can be configured in the register node by the network operator itself either on request or by mutual agreement with an external AF. In embodiments where the register node is a 5G-EIR, the ability to configure the triggers in the 5G-EIR can be achieved by a NEF exposing an interface of the 5G-EIR to nodes external to the communication network.

The register node trigger can be generated by the register node during the wireless device registration flow, when the identifier (e.g. PEI, IMEI, SUPI, GPSI) of the wireless device is checked against the register node database/list. Based on the register node configuration, the trigger can be generated for any specific, black-listed or grey-listed wireless devices. The register node may use the communication network's Internet gateway to send the notification to the external AF.

Once the external AF has received the trigger indicating that a specified wireless device is connecting to the communication network, the external AF (which can be, for example, a government's intelligence agency server) can apply or request location tracking using the GMLC or other location server in the communication network. The external AF may comprise or operate as a LCS client according to 3GPP TS 23.273 v17.0.0.

The proposed techniques can provide any one or more of the following advantages.

For example, real-time automatic information about the switching-on of any suspected wireless device (UE) can be sent to any external application (such as a government intelligence agency) deployed or hosted outside of network operator's environment. This will enable the automation of location applications for automatic real-time tracking of wireless devices without manual intervention, and will also enhance security measures against unidentified wireless devices.

As another example, the proposed techniques can reduce the unnecessary load on the network operator's GMLC by informing external applications about the switching-on of suspicious wireless devices. An external application that has LCS capability can apply tracking, or send location requests to the GMLC, only after receiving the switching-on trigger from the communication network. This can reduce the network operator's dimensioning cost for the GMLC.

As another example, the proposed techniques can reduce the network load between location-based external applications and the network operator's environment, i.e. the GMLC.

As another example, the communication network can be used as a honey pot to allow the latching or connecting of suspicious wireless devices to enable automated tracking, irrespective of whether the wireless device is also present in a black list and/or grey list.

In a scenario where the network operator has deployed its own location application (e.g. a LCS client) for use by intelligence agencies or external organizations, substantial license costs can be saved in models where the license cost is based on the number of requests initiated or processed.

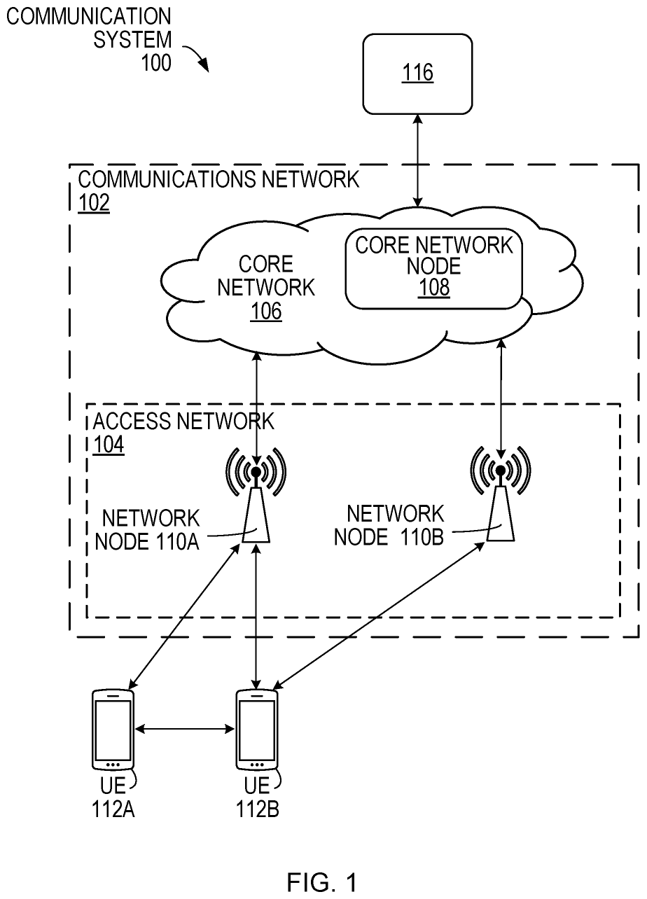

FIG. 1 shows an example of a communication system 100 in accordance with some embodiments. In the example, the communication system 100 includes a communication network 102 that includes an access network 104, such as a radio access network (RAN), and a core network 106 connected to the access network 104, which includes one or more core network nodes 108. The access network 104 includes one or more access network nodes, such as access network nodes 110a and 110b (one or more of which may be generally referred to as access network nodes 110), or any other similar 3rd Generation Partnership Project (3GPP) access node or non-3GPP access point. The access network nodes 110 facilitate direct or indirect connection of wireless devices (also referred to interchangeably herein as user equipment (UE), such as by connecting UEs 112a and 112b (one or more of which may be generally referred to as UEs 112) to the core network 106 over one or more wireless connections. The access network nodes 110 may be, for example, access points (APs) (e.g. radio access points), base stations (BSs) (e.g. radio base stations, Node Bs, evolved Node Bs (eNBs) and NR NodeBs (gNBs).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The wireless devices/UEs 112 may be any of a wide variety of communication devices, including wireless devices arranged, configured, and/or operable to communicate wirelessly with the network nodes 110 and other communication devices. Similarly, the access network nodes 110 are arranged, capable, configured, and/or operable to communicate directly or indirectly with the UEs 112 and/or with other network nodes or equipment in the communication network 102 to enable and/or provide network access, such as wireless network access, and/or to perform other functions, such as administration in the communication network 102.

In the depicted example, the core network 106 is connected to one or more external client nodes 116. This connection may be direct or indirect via one or more intermediary networks or devices. In other examples, network nodes may be directly coupled to client nodes 116. The core network 106 includes one more core network nodes (e.g. core network node 108) that are structured with hardware and software components. Features of these components may be substantially similar to those described with respect to the wireless devices/UEs, access network nodes, and/or client nodes, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), an Equipment Identity Register (EIR) and/or a User Plane Function (UPF).

The client node 116 may be under the ownership or control of a service provider other than an operator or provider of the access network 104 and/or the communication network 102, and may be operated by the service provider or on behalf of the service provider. The client node 116 may host a variety of applications to provide one or more services. Examples of such applications include data collection services, including location-based services, i.e. services that make use of information on the location of the UE 112.

As a whole, the communication system 100 of FIG. 1 enables connectivity between the wireless devices/UEs, network nodes, and client nodes. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network 102 is a cellular network that implements 3GPP standardized features. Accordingly, the communications network 102 may support network slicing to provide different logical networks to different devices that are connected to the communication network 102. For example, the communication network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

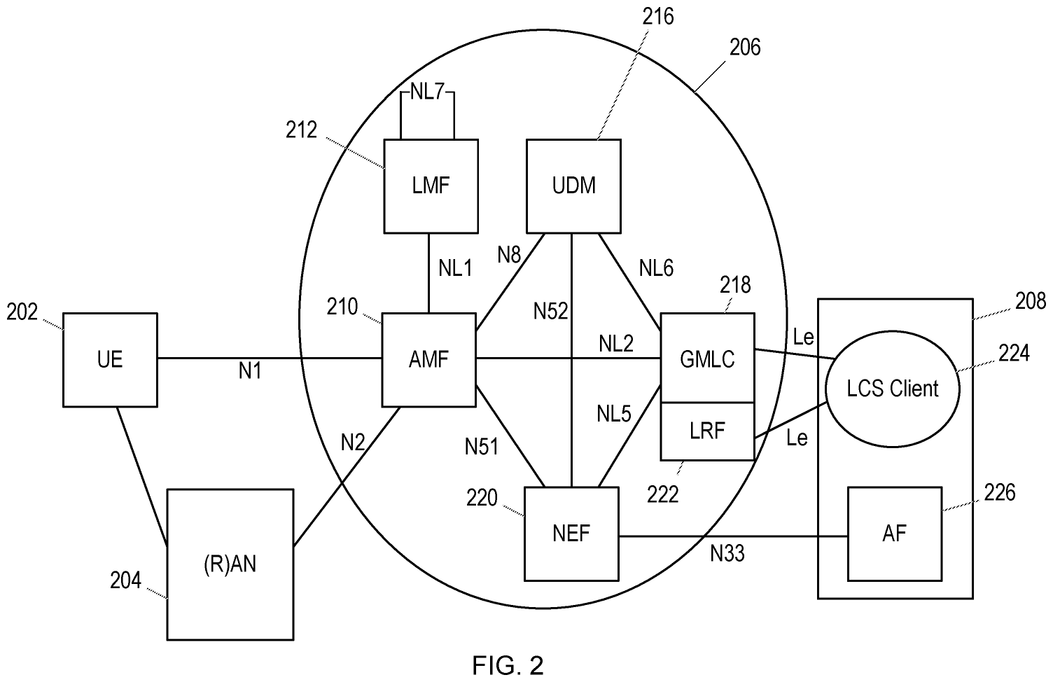

FIG. 2 is an illustration of the logical connections in the communication system of FIG. 1. In the embodiment of FIG. 2, the communication system operates according to the 5G/NR standards. FIG. 2 shows a UE 202 connected to a (radio) access network 204, a core network 206 and a client node 208.

The UE 202 is connected to an Access and Mobility Function (AMF) 210 in the core network 206 via an N1 interface and the RAN 204 is connected to the AMF 210 via an N2 interface. The AMF 210 is connected to other nodes in the core network 206, including a Location Management Function (LMF) 212 via a NL1 interface, a Unified Data Management (UDM) node 216 via a N8 interface, a GMLC 216 via a NL2 interface, and a NEF 220 via a N51 interface. The UDM 214 and the NEF 220 are interconnected via a N52 interface. The GMLC 218 is connected to the UDM 216 and NEF 220 via NL6 and NL5 interfaces respectively. The GMLC 218 is connected to a Location Retrieval Function (LRF) 222, and the GMLC 218 and the LRF 222 are connected to a LCS Client 224 in the client node 208 via a Le interface. The NEF 220 is connected to an Application Function (AF) 226 in the client node 208 via a N33 interface.

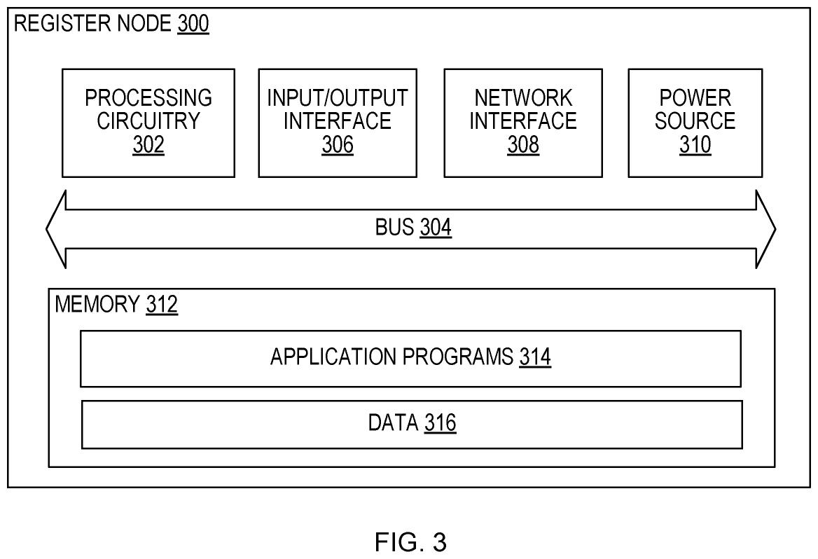

FIG. 3 is a block diagram of a register node 300, in accordance with various aspects described herein. The register node 300 may be an EIR, e.g. a 4G-EIR or a 5G-EIR. As used herein, the register node 300 may be or comprise various combinations hardware and/or software, including a standalone server, a blade server, a cloud-implemented server, a distributed server, a virtual machine, container, or processing resources in a server farm. The register node 300 may maintain one or more lists of UEs/wireless devices that are allowed to connect, or are not allowed to connect, to the communication network 102. Such lists can be referred to as black lists, grey lists and white lists.

The register node 300 includes processing circuitry 302 that is operatively coupled via a bus 304 to an input/output interface 306, a network interface 308, a power source 310, and a memory 312. Other components may be included in other embodiments.

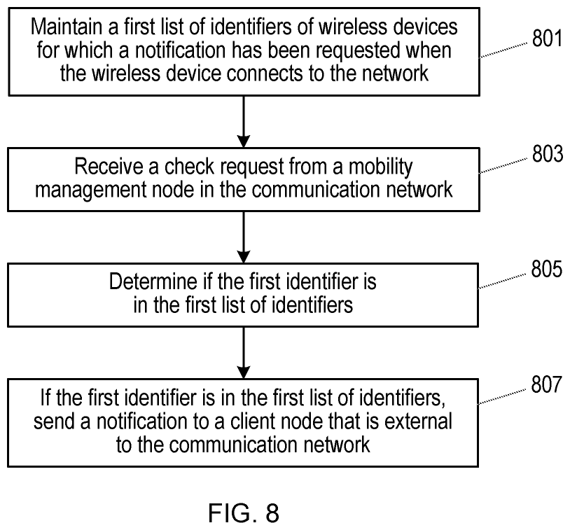

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other register node 300 components, such as the memory 312, to provide register node 300 functionality. For example, the processing circuitry 302 may be configured to cause the register node to perform the methods as described with reference to FIG. 8.

In some embodiments, the processing circuitry 302 includes a system on a chip (SOC).

The memory 312 may include one or more computer programs including one or more application programs 314 and data 316, which may include list data, e.g. the list(s) of wireless device identifiers. Embodiments of the register node 300 may utilize only a subset or all of the components shown. The application programs 314 may be implemented in a container-based architecture.

The memory 312 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 312. The memory 312 may store any suitable instructions, data, or information, including a computer program, software, an application including one or more of logic, rules, code, tables, and/or other instructions capable of being executed by the processing circuitry 302 and utilized by the register node 300. The memory 312 may be used to store any calculations made by the processing circuitry 302 and/or any data received via the network interface 308. In some embodiments, the processing circuitry 302 and memory 312 is integrated.

The network interface 308 is used in wired or wireless communication of signalling and/or data between core network nodes, such as an MME or AMF.

The power source 310 provides power to the various components of register node 300 in a form suitable for the respective components (e.g. at a voltage and current level needed for each respective component). The power source 310 may further comprise, or be coupled to, power management circuitry to supply the components of the register node 300 with power for performing the functionality described herein. For example, the register node 300 may be connectable to an external power source (e.g. the power grid, an electricity outlet) via an input circuitry or interface such as an electrical cable, whereby the external power source supplies power to power circuitry of the power source 310. As a further example, the power source 310 may comprise a source of power in the form of a battery or battery pack which is connected to, or integrated in, power circuitry. The battery may provide backup power should the external power source fail.

The input/output interface 306 can allow input of information into the register node 300 and to allow output of information from the register node 300. This may allow a user to perform diagnostic, maintenance, repair, and other administrative functions for the register node 300.

Embodiments of the register node 300 may include additional components beyond those shown in FIG. 3 for providing certain aspects of the register node's functionality, including any of the functionality described herein and/or any functionality necessary to support the subject matter described herein.

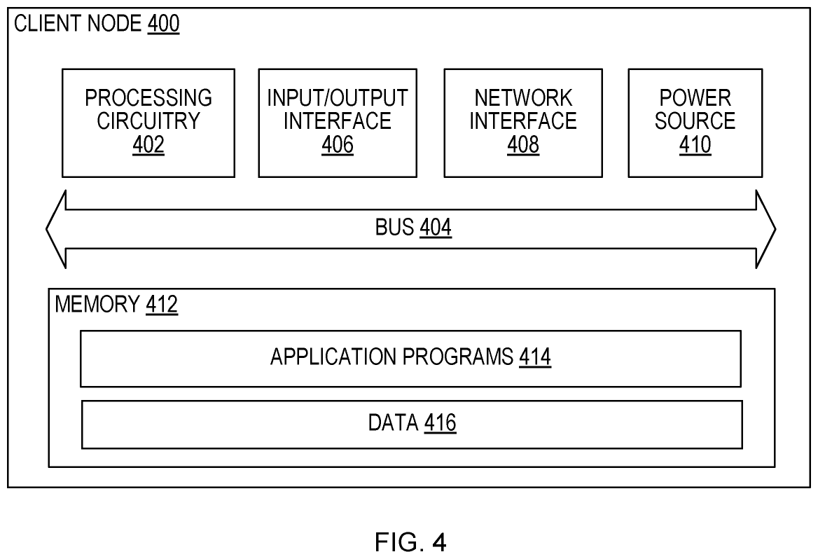

FIG. 4 is a block diagram of a client node 400, in accordance with various aspects described herein. The client node 400 may be, or include, an AF (e.g. AF 226) and a LCS (e.g. 224). As used herein, the client node 400 may be or comprise various combinations hardware and/or software, including a standalone server, a blade server, a cloud-implemented server, a distributed server, a virtual machine, container, or processing resources in a server farm.

The client node 400 includes processing circuitry 402 that is operatively coupled via a bus 404 to an input/output interface 406, a network interface 408, a power source 410, and a memory 412. Other components may be included in other embodiments.

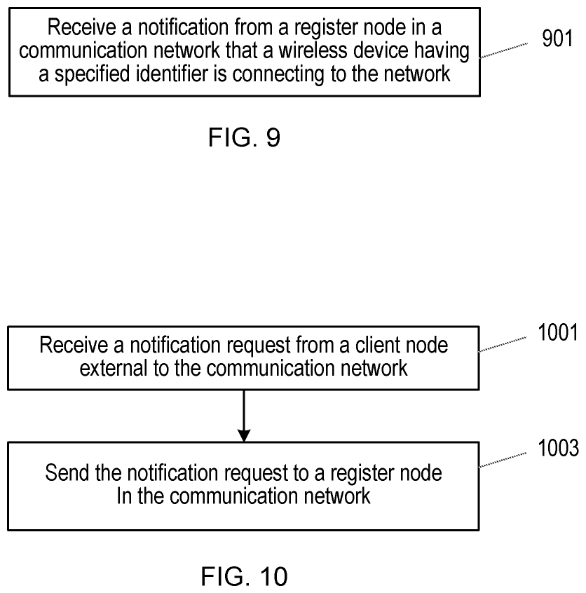

The processing circuitry 402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other client node 400 components, such as the memory 412, to provide client node 400 functionality. For example, the processing circuitry 402 may be configured to cause the client node to perform the methods as described with reference to FIG. 9.

In some embodiments, the processing circuitry 402 includes a SOC.

The memory 412 may include one or more computer programs including one or more application programs 414 and data 416. Embodiments of the client node 400 may utilize only a subset or all of the components shown. The application programs 414 may be implemented in a container-based architecture.

The memory 412 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a CD or a DVD), and/or any other volatile or non-volatile, non-transitory device-readable and/or computer-executable memory devices that store information, data, and/or instructions that may be used by the processing circuitry 412. The memory 412 may store any suitable instructions, data, or information, including a computer program, software, an application including one or more of logic, rules, code, tables, and/or other instructions capable of being executed by the processing circuitry 402 and utilized by the client node 400. The memory 412 may be used to store any calculations made by the processing circuitry 402 and/or any data received via the network interface 408. In some embodiments, the processing circuitry 402 and memory 412 is integrated.

The network interface 408 is used in wired or wireless communication of signalling and/or data to the NEF 220 and/or GMLC 218.

The power source 410 provides power to the various components of client node 400 in a form suitable for the respective components (e.g. at a voltage and current level needed for each respective component). The power source 410 may further comprise, or be coupled to, power management circuitry to supply the components of the client node 400 with power for performing the functionality described herein. For example, the client node 400 may be connectable to an external power source (e.g. the power grid, an electricity outlet) via an input circuitry or interface such as an electrical cable, whereby the external power source supplies power to power circuitry of the power source 410. As a further example, the power source 410 may comprise a source of power in the form of a battery or battery pack which is connected to, or integrated in, power circuitry. The battery may provide backup power should the external power source fail.

The input/output interface 406 can allow input of information into the client node 400 and to allow output of information from the client node 400. This may allow a user to perform diagnostic, maintenance, repair, and other administrative functions for the client node 400.

Embodiments of the client node 400 may include additional components beyond those shown in FIG. 4 for providing certain aspects of the client node's functionality, including any of the functionality described herein and/or any functionality necessary to support the subject matter described herein.

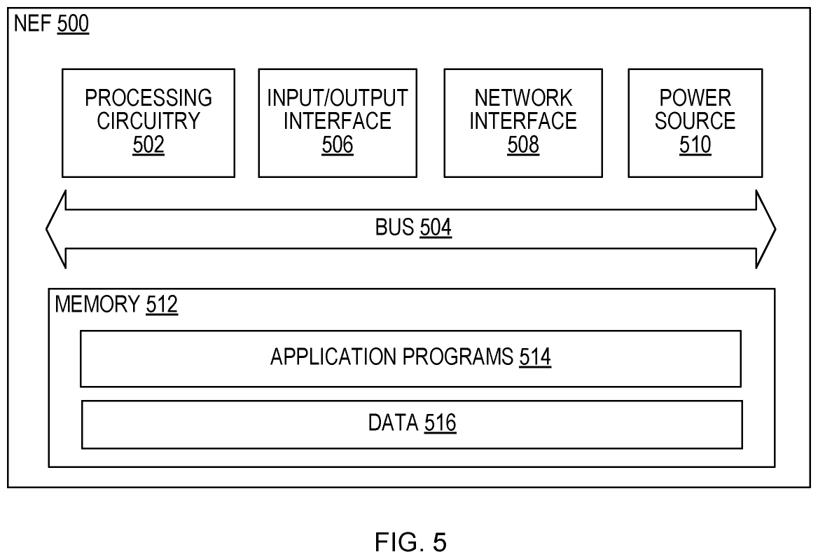

FIG. 5 is a block diagram of a NEF 500, in accordance with various aspects described herein. As used herein, the NEF 500 may be or comprise various combinations hardware and/or software, including a standalone server, a blade server, a cloud-implemented server, a distributed server, a virtual machine, container, or processing resources in a server farm.

The NEF 500 includes processing circuitry 502 that is operatively coupled via a bus 504 to an input/output interface 506, a network interface 508, a power source 510, and a memory 512. Other components may be included in other embodiments.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other NEF 500 components, such as the memory 512, to provide NEF 500 functionality. For example, the processing circuitry 502 may be configured to cause the NEF to perform the methods as described with reference to FIG. 10.

In some embodiments, the processing circuitry 502 includes a SOC.

The memory 512 may include one or more computer programs including one or more application programs 514 and data 516. Embodiments of the NEF 500 may utilize only a subset or all of the components shown. The application programs 514 may be implemented in a container-based architecture.

The memory 512 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a CD or a DVD), and/or any other volatile or non-volatile, non-transitory device-readable and/or computer-executable memory devices that store information, data, and/or instructions that may be used by the processing circuitry 512. The memory 512 may store any suitable instructions, data, or information, including a computer program, software, an application including one or more of logic, rules, code, tables, and/or other instructions capable of being executed by the processing circuitry 502 and utilized by the NEF 500. The memory 512 may be used to store any calculations made by the processing circuitry 502 and/or any data received via the network interface 508. In some embodiments, the processing circuitry 502 and memory 512 is integrated.

The network interface 508 is used in wired or wireless communication of signalling and/or data to a client node 400 and/or a register node 300.

The power source 510 provides power to the various components of NEF 500 in a form suitable for the respective components (e.g. at a voltage and current level needed for each respective component). The power source 510 may further comprise, or be coupled to, power management circuitry to supply the components of the NEF 500 with power for performing the functionality described herein. For example, the NEF 500 may be connectable to an external power source (e.g. the power grid, an electricity outlet) via an input circuitry or interface such as an electrical cable, whereby the external power source supplies power to power circuitry of the power source 510. As a further example, the power source 510 may comprise a source of power in the form of a battery or battery pack which is connected to, or integrated in, power circuitry. The battery may provide backup power should the external power source fail.

The input/output interface 506 can allow input of information into the NEF 500 and to allow output of information from the NEF 500. This may allow a user to perform diagnostic, maintenance, repair, and other administrative functions for the NEF 500.

Embodiments of the NEF 500 may include additional components beyond those shown in FIG. 5 for providing certain aspects of the NEF's functionality, including any of the functionality described herein and/or any functionality necessary to support the subject matter described herein.

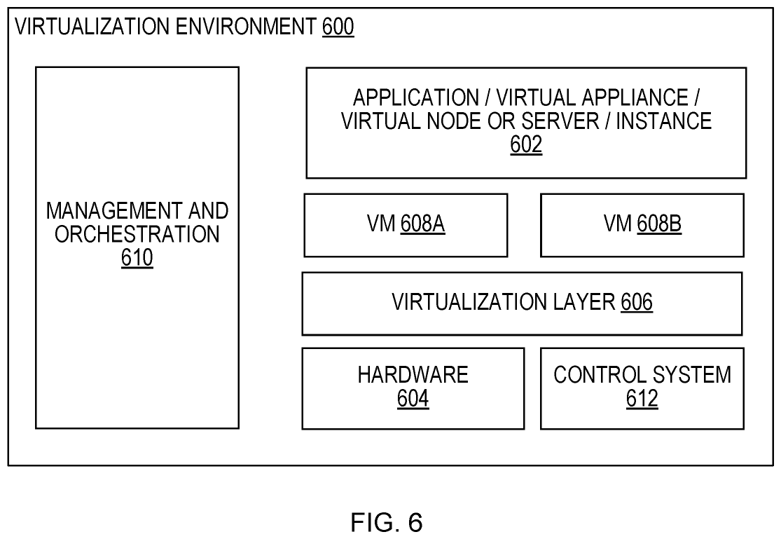

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 600 hosted by one or more of hardware nodes, such as a hardware computing device that operates as a register node 300, a client node 400, or a NEF 500.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or virtual machine monitors (VMMs)), provide VMs 608a and 608b (one or more of which may be generally referred to as VMs 608), and/or perform any of the functions, features and/or benefits described in relation with some embodiments described herein. The virtualization layer 606 may present a virtual operating platform that appears like networking hardware to the VMs 608.

The VMs 608 comprise virtual processing, virtual memory, virtual networking or interface and virtual storage, and may be run by a corresponding virtualization layer 606. Different embodiments of the instance of a virtual appliance 602 may be implemented on one or more of VMs 608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 608 may be a software implementation of a physical machine that runs programs as if they were executing on a physical, non-virtualized machine. Each of the VMs 608, and that part of hardware 604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 608 on top of the hardware 604 and corresponds to the application 602.

Hardware 604 may be implemented in a standalone network node with generic or specific components. Hardware 604 may implement some functions via virtualization. Alternatively, hardware 604 may be part of a larger cluster of hardware (e.g. such as in a data center or CPE) where many hardware nodes work together and are managed via management and orchestration 610, which, among others, oversees lifecycle management of applications 602.

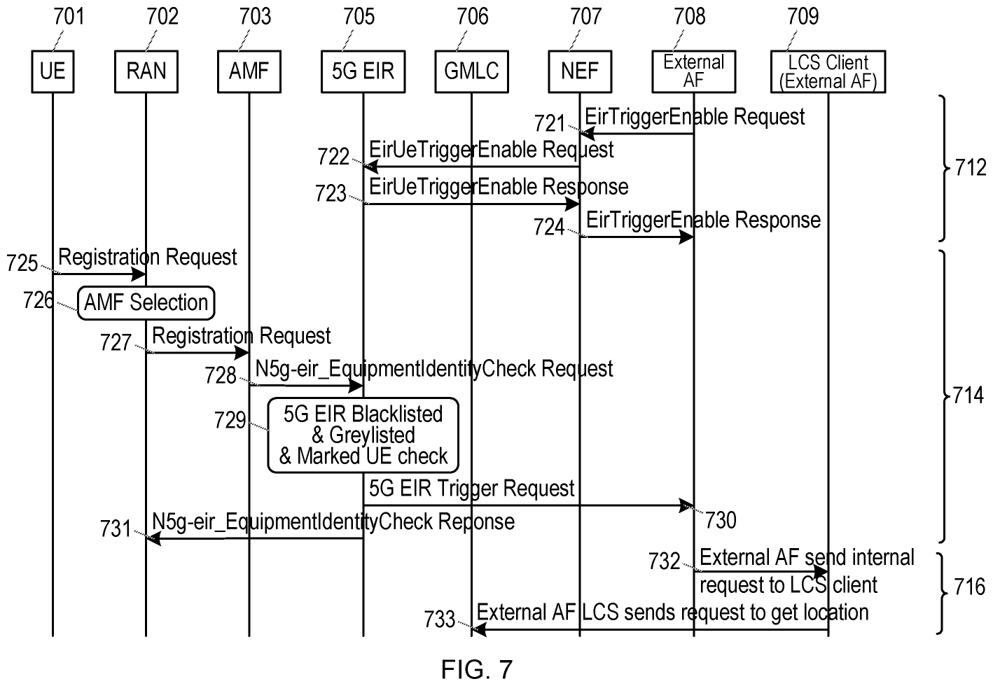

The signalling diagram in FIG. 7 illustrates the monitoring of wireless devices (UEs) in a communication network in accordance with some embodiments. In the example represented by FIG. 7, the communication network operates according to the 5G/NR standards. FIG. 7 shows the signalling between UE 701, RAN 702, AMF 703, 5G-EIR 705, GMLC 706, NEF 707, External AF 708 and LCS Client 709. It will be appreciated that the external AF 708 and LCS client 709 can be implemented as a single client node.

FIG. 7 shows three main processes in the monitoring of UE 701. The first process 712 relates to the signalling required to inform the 5G-EIR of the UEs for which the external AF 708/LCS client 709 require a trigger or notification when the UE 701 attempts to connect to the communication network. The second process 714 relates to the checking of the UE identifier and the sending of the trigger/notification. The third process 716 relates to the LCS client 709 initiating location tracking or otherwise obtaining location information for the UE 701.

The 5G-EIR 705 is configured with a method which will allow any authorized external AF 708 to enable a ‘switch-on’ trigger based on a UE identifier such as a PEI, IMEI, SUPI or GPSI for any specified UE. An authorized external AF 708 may already be registered with the network operator so that the external AF 708 can receive trigger notifications from the 5G-EIR 705.

A trigger enablement interface API is proposed that can be used via the NEF 707 in a similar way to the other interfaces mentioned 3GPP TS 29.122 v17.1.0. In other words, the NEF 707 will expose a north bound interface which will allow an external AF 708 to configure the trigger functionality in the 5G-EIR 705. This new 5G-EIR interface is referred to as “EirUeTriggerEnable interface”, and the interface at the NEF 707 is referred to as “EirTriggerEnable API”.

Thus, the 5G-EIR 705 is equipped with a mechanism to configure the necessary trigger and define the service location and configuration for the external AF 708. The service hosted can be a REST-based service which accepts JavaScript Object Notation (JSON) requests. The external AF 708 service location can persist in a User Data Repository (UDR 706) and can be configured from the network operator's common configuration graphical user interface (GUI) or from the GUI of the 5G-EIR 705. This can be configured prior to the start of the method shown in FIG. 7.

Table 1 below shows an exemplary configuration for the external AF 708 and service uniform resource locator (URL) mapping when it is desired for the trigger to be received by external AF 708.

TABLE 1

| External | | |
|---|---|---|
| AF id | External AF service URL | Description |
| AF1 | http://Server1.government.co.in/handsets | RAW server North |
| | | Zone |
| AF2 | http://Intelligenceservice.com/trigger | RAW server South |
| | | Zone |

Thus, Table 1 shows the URL for two different external AFs, AF1 and AF2. Any trigger due to a specified UE connecting to the communication network will be sent to these AFs.

Referring to FIG. 7, initially the external AF 708 wants to set up trigger notifications for one or more UEs of interest, including UE 701. The UE(s) of interest may be UEs that have been reported lost or stolen, or are known to be used and/or used by criminals, and the external AF 708 wants to know when any of these UEs connect, or try to connect, to the communication network.

Thus, the external AF 708 sends a request 721 to the NEF 707. Request 721 is sent by the external AF 708 to activate a trigger notification for one or more UEs 701 so that the external AF 708 is notified when any of those UEs 701 connect to the network. This request 721 is named the “EirTriggerEnable request”. The request 721 includes or comprises an identifier for one or more UEs 701 that a trigger is required for by the external AF 708. The identifier can be any of a PEI, IMEI, SUPI or GPSI.

In embodiments where the identifier is the PEI, the EirTriggerEnable Request 721 can include the following parameter:

TABLE 2

| Parameters | status | Description |
|---|---|---|
| PEI | Mandatory | The PEI of the UE shall be included for |
| | | equipment identity checking |

The NEF 707 sends or forwards the request to the 5G-EIR 705 (signal 722). This signal 722 is named the “EirUeTriggerEnable request”. This request 722 also includes or comprises the identifiers for the UE(s) that were in request 721.

The EirUeTriggerEnable Request 722 can include the following parameter:

TABLE 3

| Parameters | status | Description |
|---|---|---|
| PEI | Mandatory | The PEI of the UE shall be included for |
| | | equipment identity checking |

The 5G-EIR 705 receives the EirUeTriggerEnable request 722 and sets a trigger for the UE 701 identified in the request 722. Setting the trigger for the UE 701 can comprise adding the identifier of the UE 701 to a list stored by the 5G-EIR 705. This list may be separate to a black list, grey list and/or white list maintained by the 5G-EIR 705, or a flag can be placed against the relevant UE(s) 701 if they are present in the black, grey or white lists. In either case, the information about the UE 701 that a trigger is required for is stored in a database of the 5G-EIR 705, in a similar way to the way that a 5G-EIR maintains the current black, grey and/or white lists.

It should be noted that the UEs (or rather the identifiers) that the trigger enable request 721/722 relates do not have to be UEs (or rather the identifiers) that are already on any of the black, grey or white lists maintained by the 5G-EIR 705.

The 5G-EIR 705 sends a response 723 to the NEF 707 indicating that the trigger has been set for the UE(s) identified in the request 722. This response 723 is named the “EirUeTriggerEnable Response”. The EirUeTriggerEnable Response 723 can include the following parameter:

TABLE 4

| Parameters | status | Description |
|---|---|---|
| STATUS | Mandatory | The PEI of the UE shall be included for |
| | | equipment identity checking |

The NEF 707 sends or forwards the response to the external AF 708 (signal 724). This signal 724 is named the “EirTriggerEnable Response”. The EirTriggerEnable Response 724 can include the following parameter:

TABLE 5

| Parameters | status | Description |
|---|---|---|
| STATUS | Mandatory | The PEI of the UE shall be included for |
| | | equipment identify checking |

In process 714, UE 701 attempts to register with/connect to the communication network. Thus, the UE 701 sends a registration request 725 to the RAN 702. The RAN 702 selects a suitable AMF in step 726 for registering the UE 701. The RAN 702 then forwards the registration request 727 to the selected AMF 703.

The AMF 703 supports the function to check the identity of UEs registering with the network with the 5G-EIR 705. Therefore, the AMF 703 sends a request 728 (referred to as “N5g-eir_EquipmentIdentityCheck request”) to the 5G-EIR 705. The request 728 includes the identifier of the UE 701.

3GPP TS 23.502 v17.0.0 defines the N5g-eir_EquipmentIdentityCheck request is invoked towards a 5G-EIR from an AMF to check the UE status for black-listing and grey-listing. This is shown in Table 6 below.

TABLE 6

| Service Name | Description |
|---|---|
| N5g-eir_Equipment | This service enables the 5G-EIR to check the PEI |
| Identity Check | and check whether the PEI is in the black list or not. |

In step 729 the 5G-EIR 705 checks the received identifier against the identifiers in its one or more lists, e.g. black list, grey list and/or white list. If the 5G-EIR 705 maintains a separate list for UE identifiers for which a trigger has been enabled, the 5G-EIR 705 also checks this list in step 729.

If the UE 701 (or the identifier of the UE 701 included in the registration request) has not been enabled for a trigger according to steps/signals 721-724, then the 5G-EIR 705 operates in the conventional way. That is, if the UE 701 is not in the black list (or grey list, if present), then the 5G-EIR 705 responds to the AMF 703 indicating that the UE 701 is permitted to connect to the network. Registration/connection of the UE 701 to the network then proceeds in the conventional way. On the other hand, if the UE 701 is in the black list (or grey list, if present), then the 5G-EIR 705 responds to the AMF 703 indicating that the UE 701 is not permitted to connect to the network. Rejection of the registration request then proceeds in the conventional way.

If the UE 701 has been enabled for a trigger according to steps/signals 721-724, then the 5G-EIR 705 will identify the UE 701 as such either from the flag against the UE identifier in the black list, grey list or white list, from the presence of the UE identifier in the separate list of UEs for which a trigger has been enabled. The 5G-EIR 705 sends a trigger notification 730 to the external AF 708 indicating that UE 701 has requested connection to the network. This trigger notification is referred to as “5G EIR Trigger Request”. The trigger notification can be sent to the service URL indicated for the external AF 708 in Table 1 above. The trigger notification 730 can indicate the identifier(s) of the UE 701, as shown in Table 7 below.

TABLE 7

| Parameters | status | Description |
|---|---|---|
| PEI | Mandatory | The PEI of the UE shall be included for |
| | | equipment identify checking |
| SUPI | Optional | The SUPI of the UE |
| GUSI | Optional | The GPSI of the UE |

Therefore, process 714 ensures that the external AF 708 is notified by the 5G-EIR 705 when a specified UE 701 tries to connect to the network.

Having determined in step 729 that the UE 701 has been enabled for a trigger, the 5G-EIR 705 sends a response 731 to the AMF 703. The response 731 is the response to the check request 728, and the response 731 indicates whether or not the UE 701 is to be permitted to connect to the network.

In some embodiments, whether or not the UE 701 can connect to the network depends on whether the identifier of the UE 701 is present in the black or grey lists maintained by the 5G-EIR 705. Thus, the response 731 can indicate that the UE 701 is not permitted to connect to the network if the identifier of the UE 701 is on the black or grey lists, and the response 731 can indicate that the UE 701 can connect to the network if the identifier of the UE 701 is not on the black or grey lists.

Alternatively, in other embodiments the response 731 sent by the 5G-EIR 705 indicates that the UE 701 can connect to the network, even if the UE 701 was also present in the black list or grey list. These embodiments enable the UE 701 to connect to the network so that the official entity (e.g. government intelligence agency) associated with the external AF 708 can monitor the UE 701 in the network.

In process 716, which occurs when or after the external AF 708 receives the trigger notification 730, the external AF 708 can send an internal notification/request 732 to the LCS client 709 within its application environment. In embodiments where the network operator has deployed its own LCS client 709, the external AF 708 can invoke the LCS client at the network operator's site.

As the external AF 708/LCS client 709 knows that the UE 701 is now connected to the network, the LCS client 709 can start tracking the location of the UE 701. The LCS client 709 is a logical functional entity that sends a request 733 to the GMLC 706 to obtain the location of the UE 701 in the network. Although not shown in FIG. 7, the GMLC 706 can provide the requested location information to the LCS client 709.

Thus, the introduction of the 5G-EIR trigger as described above provides the ability for external AFs and/or LCS client applications to build capability around only requesting and applying location requests or tracking when the specified UE is switched on and connected to the network. Moreover, the external AF and/or LCS client can be configured to automatically start tracking a UE on receiving the trigger notification from 5G-EIR. This will reduce unnecessary load on the GMLC by avoiding the sending of location requests for a UE that is not connected to the network.

FIG. 8 is a flow chart illustrating a method according to various embodiments performed by a register node, such as an EIR, a 4G-EIR or a 5G-EIR. The register node may perform the method in response to executing suitably formulated computer readable code. The computer readable code may be embodied or stored on a computer readable medium, such as a memory chip, optical disc, or other storage medium. The computer readable medium may be part of a computer program product.

In step 801 the register node maintains a first list of identifiers of wireless devices (UEs) for which a notification has been requested when the wireless device connects to the communication network. The identifiers can be any of an IMEI, a PEI, a SUPI and a GPSI.

In step 803, the register node receives a check request from a mobility management node in the communication network. The check request comprises a first identifier of a wireless device that is requesting access to the communication network. The mobility management node can be a MME or an AMF. The check request can be the N5g-eir_EquipmentIdentityCheck request 728 described above with respect to FIG. 7.

In step 805, the register node determines if the first identifier is in the first list of identifiers. Step 805 can be performed in a similar way to step 729 in FIG. 7.

If the first identifier is in the first list of identifiers, then in step 807 the register node sends a notification to a client node that is external to the communication network. The notification indicates that a wireless device having the first identifier is connecting to the communication network. The client node can be an external AF or a LCS client. The notification sent in step 807 can be, or be similar to, the 5G EIR Trigger Request 730 in FIG. 7.

In some embodiments, the notification is only sent in step 807 if the first identifier is in the first list of identifiers.

In some embodiments, if the first identifier is in the first list of identifiers, the register node can send a check response to the mobility management node. The check response indicates that the wireless device having the first identifier is permitted to connect to the communication network. The check response can be, or be similar to, the N5g-eir_EquipmentIdentityCheck Response 731 in FIG. 7.

In some embodiments, the list maintained in step 801 is a black list, i.e. a list of identifiers of wireless devices that are not permitted to connect to the network. In some embodiments, the list maintained in step 801 is a grey list, i.e. a list of wireless device models or software versions that are not permitted to connect to the network.

In some embodiments, the register node maintains a second list of identifiers of wireless devices for which access to the communication network is to be blocked or prevented from connecting the communication network. This second list can be a black list or grey list. Then, in step 805, the register node determines if the first identifier is in the first list of identifiers or the second list of identifiers. If the first identifier is in both lists, i.e. a notification has been requested when the wireless device connects to the network, but the wireless device is blocked from connecting to the network, the register node sends a first check response to the mobility management node indicating that the wireless device having the first identifier is permitted to connect to the communication network. In this way, the client node is able to monitor the behaviour (i.e. location) of the wireless device while it is connected to the network.

If the first identifier is not in the first list of identifiers but is in the second list of identifiers, i.e. a notification has not been requested when the wireless device connects to the network, and the wireless device is blocked from connecting to the network, the register node sends a second check response to the mobility management node indicating that the wireless device having the first identifier is not permitted to connect to the communication network.

In some embodiments, prior to step 801 the register node receives a notification request from the client node. The notification request may be received via a NEF. The notification request indicates one or more identifiers of wireless devices for which notifications are requested when those wireless devices connect to the communication network. The notification request can be, or be similar to, the EirTriggerEnable Request 721 or EirUETriggerEnable Request 722 in FIG. 7. The register node stores the identifiers in the notification request in the first list of identifiers. If the first list is a black list or a grey list and the identifier is already present in that list, the register node can place a flag against the relevant identifier in the first list to indicate that a notification has been requested.

FIG. 9 is a flow chart illustrating a method according to various embodiments performed by a client node, such as an external AF or LCS client. The client node may perform the method in response to executing suitably formulated computer readable code. The computer readable code may be embodied or stored on a computer readable medium, such as a memory chip, optical disc, or other storage medium. The computer readable medium may be part of a computer program product.

In step 901 the client node receives a notification from a register node in a communication network. The notification indicates that a wireless device having a specified identifier is connecting to the communication network. The register node can be an EIR, a 4G-EIR or a 5G-EIR. The notification sent in step 901 can be, or be similar to, the 5G EIR Trigger Request 730 in FIG. 7. The identifier can be any of an IMEI, a PEI, a SUPI and a GPSI.

In some embodiments, prior to step 901 the client node can send a notification request to the register node. The notification request indicates one or more identifiers of wireless devices for which notifications are requested when those wireless devices connect to the communication network. The notification request may be sent to the register node via a NEF. The notification request can be, or be similar to, the EirTriggerEnable Request 721 or EirUETriggerEnable Request 722 in FIG. 7.

The client node may then receive a notification response from the register node indicating that the one or more identifiers have been added to a first list of identifiers of wireless devices. The notification response can be, or be similar to, the EirUETriggerEnable Response 723 or EirTriggerEnable Response 724 in FIG. 7.

In some embodiments, after receiving the notification in step 901, the client node can send a location request to a location service node in the communication network. The location request requests information on the location of the wireless device having the specified identifier. The location service node can be a GMLC. In some embodiments, the location request is sent to the location service node via a NEF. The location request can be, or be similar to, the request 733 in FIG. 7. Subsequently, the client node can receive information on the location of the wireless device from the location service node.

FIG. 10 is a flow chart illustrating a method according to various embodiments performed by a NEF. The NEF may perform the method in response to executing suitably formulated computer readable code. The computer readable code may be embodied or stored on a computer readable medium, such as a memory chip, optical disc, or other storage medium. The computer readable medium may be part of a computer program product.

In step 1001 the NEF receives a notification request from a client node that is external to the communication network. The client node can be an external AF or a LCS client. The notification request indicates one or more identifiers of wireless devices for which notifications are requested when the wireless devices connect to the communication network. The notification request can be, or be similar to, the EirTriggerEnable Request 721 in FIG. 7. The one or more identifiers can be any of an IMEI, a PEI, a SUPI and a GPSI.

In step 1003, the NEF sends the notification request to a register node in the communication network. The register node can be an EIR, such as a 4G-EIR or a 5G-EIR.

In some embodiments, the NEF can receive a notification response from the register node indicating that the one or more identifiers have been added to a first list of identifiers of wireless devices. The notification response received from the register node can be, or be similar to, the EirUETriggerEnable Response 723 in FIG. 7.

The NEF then sends the notification response to the client node. The notification response sent to the client node can be, or be similar to, the EirTriggerEnable Response 724 in FIG. 7.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method, the method comprising:
a register node maintaining a first list of identifiers of wireless devices for which a notification has been requested when the wireless device connects to the communication network;
the register node receiving a check request from a mobility management node in the communication network, the check request comprising a first identifier of a wireless device that is requesting access to the communication network;
the register node determining whether the first identifier is in the first list of identifiers; and
as a result of determining that the first identifier is in the first list of identifiers, sending a notification to a client node that is external to the communication network, the notification indicating that a wireless device having the first identifier is connecting to the communication network.

2. (canceled)

3. The method of claim 1, wherein the method further comprises:
if the first identifier is in the first list of identifiers, sending a check response to the mobility management node, the check response indicating that the wireless device having the first identifier is permitted to connect to the communication network.

4. The method of claim 1, wherein the method further comprises:
maintaining a second list of identifiers of wireless devices for which access to the communication network is to be blocked or prevented from connecting the communication network;
after receiving the check request from the mobility management node, determining if the first identifier is in the second list of identifiers; and
if the first identifier is in the first list of identifiers and the second list of identifiers, sending a first check response to the mobility management node, the first check response indicating that the wireless device having the first identifier is permitted to connect to the communication network.

5. The method of claim 4, wherein the method further comprises:
if the first identifier is not in the first list of identifiers and the first identifier is in the second list of identifiers, sending a second check response to the mobility management node, the second check response indicating that the wireless device having the first identifier is not permitted to connect to the communication network.

6. The method of claim 1, wherein the method further comprises:
receiving a notification request from the client node, the notification request indicating one or more identifiers of wireless devices for which notifications are requested when the wireless devices connect to the communication network; and
storing the one or more identifiers of wireless devices in the first list of identifiers.

7. The method of claim 6, wherein the notification request is received from the client node via a network exposure function, NEF, and
the client node is a location service client, LCS, or an application function, AF, associated with a LCS.

8-10. (canceled)

11. A method, the method comprising:
a client node receiving a notification from a register node in a communication network, the notification indicating that a wireless device having a specified identifier is connecting to the communication network.

12. The method of claim 11, wherein
the method further comprises: sending a notification request to the register node, the notification request indicating one or more identifiers of wireless devices for which notifications are requested when the wireless devices connect to the communication network, and
the one or more identifiers in the notification request includes the specified identifier.

13. (canceled)

14. The method of claim 12, wherein the method further comprises:
receiving a notification response from the register node, the notification response indicating that the one or more identifiers have been added to a first list of identifiers of wireless devices for which notifications are requested when the wireless device connects to the communication network.

15. The method of claim 12, wherein the notification request is sent to the register node via a network exposure function, NEF, in the communication network.

16. The method of claim 11, wherein the method further comprises:
after receiving the notification, sending a location request to a location service node in the communication network, the location request requesting information on the location of the wireless device having the specified identifier.

17. The method of claim 16, wherein the method further comprises:
receiving information on the location of the wireless device from the location service node.

18. The method of claim 16, wherein the location request is sent to the location service node via a network exposure function, NEF, in the communication network.

19. The method of claim 11, wherein the specified identifier is one or more of: an International Mobile Equipment Identity, IMEI; a Permanent Equipment Identifier, PEI; a Subscription Permanent Identifier, SUPI; and a General Public Subscription Identifier, GPSI.

20. The method of claim 11, wherein
the register node is an Equipment Identity Register, EIR, and
the client node is a location service client, LCS, or an application function, AF, associated with a LCS.

21. (canceled)

22. A method of operating a network exposure function (NEF) in a communication network, the method comprising:
receiving a notification request from a client node external to the communication network, the notification request indicating one or more identifiers of wireless devices for which notifications are requested when the wireless devices connect to the communication network; and
sending the notification request to a register node in the communication network.

23. The method of claim 22, wherein the method further comprises:
receiving a notification response from the register node, the notification response indicating that the one or more identifiers have been added to a first list of identifiers of wireless devices for which notifications are requested when the wireless device connects to the communication network; and
sending the notification response to the client node.

24-26. (canceled)

27. A computer program product comprising a non-transitory computer readable medium storing computer readable code for configuring a network node to perform the method of claim 1.

28-53. (canceled)

54. A register node configured for use in a communication network,
the register node comprising:
a processor; and
a memory, the memory storing instructions executable by the processor wherein the register node is operative to:
maintain a first list of identifiers of wireless devices for which a notification has been requested when the wireless device connects to the communication network;
receive a check request from a mobility management node in the communication network, the check request comprising a first identifier of a wireless device that is requesting access to the communication network;
determine if the first identifier is in the first list of identifiers; and
if the first identifier is in the first list of identifiers, send a notification to a client node that is external to the communication network, the notification indicating that a wireless device having the first identifier is connecting to the communication network.

55-63. (canceled)

64. A client node comprising:
a processor; and
a memory, the memory containing instructions executable by the processor wherein the client node is operative to:
perform the method of claim 11.

65-79. (canceled)
